(19) United States
(12) Patent Application Publication
(10) Pub. No.: US 2025/0174106 A1
(43) Pub. Date: May 29, 2025

(54) CENTRAL MONITORING OF A PLURALITY OF ENTRANCE SYSTEM INSTALLATION FOR COMPUTERIZED FAILURE PREDICTION, METHOD OF PREDICTING FAILURES AMONG A PLURALITY OF ENTRANCE SYSTEM INSTALLATIONS, COMPUTER PROGRAM PRODUCT AND COMPUTER READABLE MEDIUM

(71) Applicant: ASSA ABLOY ENTRANCE SYSTEMS AB, LANDSKRONA (SE)

(72) Inventor: Roger DREYER, Bjarred (SE)

(21) Appl. No.: 18/837,422

(22) PCT Filed: Feb. 17, 2023
(86) PCT No.: PCT/EP2023/054082

§ 371 Date: Aug. 9, 2024

(30) Foreign Application Priority Data
Feb. 22, 2022 (SE) 2230050-3

(51) Int. Cl. G08B 21/18; G06Q 10/20; G08B 31/00

(52) U.S. Cl. CPC G08B 21/187; G06Q 10/20; G08B 31/00

(57) ABSTRACT

Assa Abloy Entrance Systems AB has developed a central monitoring arrangement (110) for a plurality of entrance system installations (10; ES1-ESn). Each entrance system installation has one or more movable door members (D1 . . . Dm) and an automatic door operator (30) for causing movements of the one or more movable door members (D1 . . . Dm) between closed and open positions. The central monitoring arrangement comprises computerized failure prediction functionality (112) and a database (114). Data (115-1-115-n) is repeatedly collected individually from the entrance system installations. The collected data represents, for a defined moment in time, a plurality of intrinsic operating parameters of the automatic door operator (30) of an individual entrance system installation as well as extrinsic environmental parameters of the individual entrance system installation. The collected data is stored in the database (114) as an electronic fingerprint of the individual entrance system installation at the defined moment in time. The electronic fingerprints (EFP) as stored in the database (114) are analyzed for deviations in any of the intrinsic operating parameters in consideration of the extrinsic environmental parameters. Upon detection of a deviation for a particular entrance system installation (ES1), an alert signal (126; 136) is generated and submitted to at least one external entity (120; 130).

### TECHNICAL FIELD

The present invention generally relates to the field of entrance system installations having one or more movable door members and an automatic door operator for causing movements of the one or more movable door members between closed and open positions. More specifically, the present invention relates to a central monitoring arrangement for predicting failures among a plurality of such entrance system installations, as well as to an associated system, method, computer program product and computer readable medium.

### BACKGROUND

Entrance system installations having automatic door operators are frequently used for providing automatic opening and/or closing of one or more movable door members in order to facilitate entrance and exit to buildings, rooms and other areas. The door members may for instance be swing doors, sliding doors, revolving doors or overhead sectional doors.

Since entrance system installations having automatic door operators are typically used in public areas, user convenience is of course important. The entrance system installations need to remain long-term operational without malfunctions even during periods of heavy traffic by persons or objects passing through the entrance systems. At the same time, safety is important in order to avoid hazardous situations where a present, approaching or departing person or object (including but not limited to animals or articles brought by the person) may be hit or jammed by any of the movable door members. To this end, entrance system installations are typically equipped with a control arrangement including a controller and one or more sensor units, wherein each sensor unit is connected to the controller and is arranged to monitor a respective zone at the entrance system installation for presence or activity of a person or object.

Entrance system installations comprises mechanical and electrical parts, for instance in the automatic door operator, the transmission to the door members, and the control arrangement. Over time, these parts may be subject to wear and tear, and malfunctions can be expected to occur at some stage. There are some conflicting interests in how to handle malfunctions. One way is to establish regular inspections and maintenance sessions by service personnel. By scheduling the inspections frequently enough and by employing a wear part replacement scheme which is towards the safe side (short replacement periods), the risk for malfunctions can be lowered. However, this comes with a considerable cost penalty. Therefore, there is a tendency to resort to more moderate maintenance and wear part replacement schemes, which will inherently increase the risk for premature failures. Far from all possible failures have a deterministic occurrence pattern, nor are the expected lifetimes of wear parts always known.

Another way is to rely on feedback from users or local supervisors of the entrance system installation, who may be invited to report in any observed peculiarity in the entrance system installation, such as an unusual noise, a lower than usual door member speed, an odd behavior in the automatic operation of the movable door members, or at least to report in when an actual malfunction such as a complete breakdown has occurred to the entrance system installation. While this approach may save some costs in the short-term perspective, it is quite likely to turn out as a bad strategy in the long run, both cost-wise and in terms of security and user satisfaction. Also, not every malfunction is identifiable by the human senses.

The present inventors have realized that there is room for improvements in this field.

### SUMMARY

An object of the present invention is therefore to provide one or more improvements in failure prediction for entrance system installations having one or more movable door members and an automatic door operator for causing movements of the one or more movable door members between closed and open positions.

Accordingly, a first aspect of the present invention is a central monitoring arrangement for a plurality of entrance system installations, each having one or more movable door members and an automatic door operator for causing movements of the one or more movable door members between closed and open positions. The central monitoring arrangement comprises computerized failure prediction functionality and a database.

The computerized functionality is configured for repeatedly collecting data individually from the entrance system installations. The collected data represents, for a defined moment in time, a plurality of intrinsic operating parameters of the automatic door operator of an individual entrance system installation as well as extrinsic environmental parameters of the individual entrance system installation. The collected data is stored in the database as an electronic fingerprint of the individual entrance system installation at the defined moment in time.

The computerized failure prediction functionality is further configured for analyzing the electronic fingerprints as stored in the database for deviations in any of the intrinsic operating parameters in consideration of the extrinsic environmental parameters. The computerized failure prediction functionality is moreover configured, upon detection of a deviation for a particular entrance system installation, for generating an alert signal, and submitting the alert signal to at least one external entity.

The provision of such a central monitoring arrangement will solve or at least mitigate one or more of the problems or drawbacks identified in the above, as will be clear from the following detailed description section and the drawings.

In this document, an “intrinsic operating parameter of the automatic door operator” is generally to be understood as any property or characteristic of one or more components, parts or sub-system of the automatic door operator that can be measured, read or otherwise determined as a direct result of the operation of the automatic door operator. Furthermore, an “extrinsic environmental parameter of the [individual] entrance system installation” is generally to be understood as any property or characteristic of the entrance system installation's operating environment, which however does not pertain to a property or characteristic of one or more components, parts or sub-system of the automatic door operator as such. An extrinsic environmental parameter is thus extrinsic in that it does not directly relate to the internal operation of the automatic door operator but rather to the contextual environment in which the automatic door operator operates.

Non-limiting examples of intrinsic operating parameters and extrinsic environmental parameters will be given in the detailed description section.

A second aspect of the present invention is a system which comprises a central monitoring arrangement according to the first aspect of the present invention, as well as a plurality of entrance system installations. Each individual entrance system installation has one or more movable door members and an automatic door operator for causing movements of the one or more movable door members between closed and open positions. Each individual entrance system installation is configured for repeatedly providing data to the central monitoring arrangement. The provided data represents, for a defined moment in time, a plurality of intrinsic operating parameters of the automatic door operator of the individual entrance system installation as well as extrinsic environmental parameters of the individual entrance system installation.

A third aspect of the present invention is a method of predicting failures among a plurality of entrance system installations, each having one or more movable door members and an automatic door operator for causing movements of the one or more movable door members between closed and open positions. The method comprises repeatedly collecting data individually from the entrance system installations. The collected data represents, for a defined moment in time, a plurality of intrinsic operating parameters of the automatic door operator of an individual entrance system installation as well as extrinsic environmental parameters of the individual entrance system installation. The method further comprises storing, in a database, the collected data as an electronic fingerprint of the individual entrance system installation at the defined moment in time.

The method moreover comprises analyzing the electronic fingerprints as stored in the database for deviations in any of the intrinsic operating parameters in consideration of the extrinsic environmental parameters. Upon detection of a deviation for a particular entrance system installation, the method generates an alert signal and submits the alert signal to at least one external entity.

Embodiments of the method may comprise the functionality of the central monitoring arrangement as defined for the first aspect of the present invention as referred to above, and/or the functionality of any or all of the embodiments of the central monitoring arrangement as described in this document.

A fourth aspect of the present invention is a computer program product comprising computer code for performing the method according to the third aspect when the computer program code is executed by a processing device.

A fifth aspect of the present invention is a computer readable medium having stored thereon a computer program comprising computer program code for performing the method according to the third aspect when the computer program code is executed by a processing device.

The provision of such a system, method, computer program product and computer readable medium will solve or at least mitigate one or more of the problems or drawbacks identified in the above, as will be clear from the following detailed description section and the drawings.

In different embodiments, the one or more movable door members may, for instance, be swing door members, sliding door members, revolving door members, (overhead) sectional door members or pull-up door members.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Objects, features and advantages of embodiments of the invention will appear from the following detailed description, reference being made to the accompanying drawings.

FIG. 1 is a schematic block diagram of an entrance system installation which may be subject to failure prediction generally according to the present invention.

FIG. 2 is a schematic block diagram of an automatic door operator which may be included in the entrance system installation shown in FIG. 1.

FIG. 3 is a schematic block diagram of a system which comprises a central monitoring arrangement and a plurality of entrance system installations.

FIG. 4 is a schematic top view of an entrance system installation according to a first embodiment, in the form of a sliding door system.

FIG. 5 is a schematic top view of an entrance system installation according to a second embodiment, in the form of a swing door system.

FIG. 6 is a schematic top view of an entrance system installation according to a third embodiment, in the form of a revolving door system.

FIG. 7 is a flowchart diagram illustrating a method of predicting failures among a plurality of entrance system installations generally according to the present invention.

FIG. 8 is a schematic illustration of a computer-readable medium in one exemplary embodiment, capable of storing a computer program product.

### DETAILED DESCRIPTION OF EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

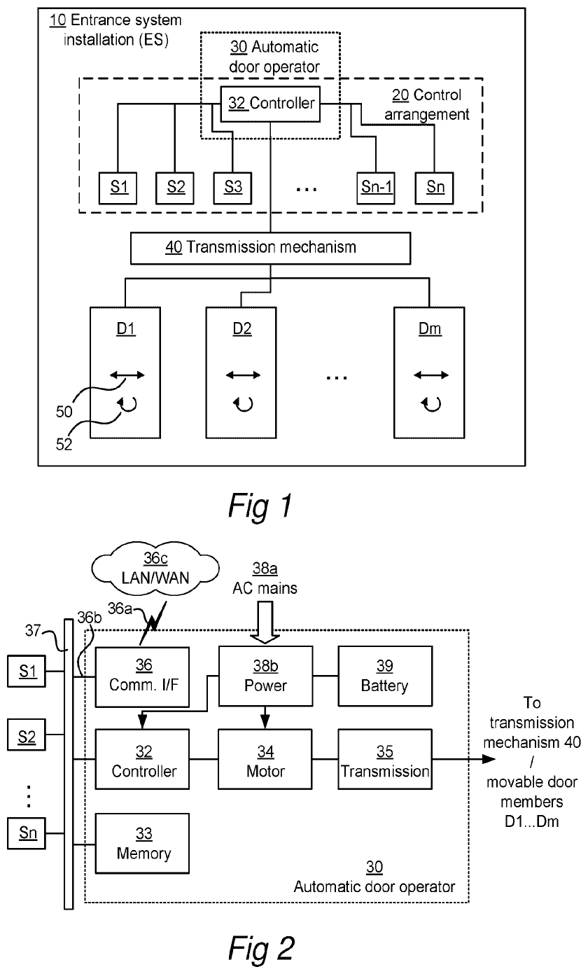

FIG. 1 is a schematic block diagram illustrating an entrance system installation 10 to which the inventive aspects of the present invention may be applied.

The entrance system installation 10 comprises one or more movable door members D1 . . . Dm, and an automatic door operator 30 for causing movements of the door members D1 . . . Dm between closed and open positions. In FIG. 1, a transmission mechanism 40 conveys mechanical power from the automatic door operator 30 to the movable door members D1 . . . Dm. FIG. 2 illustrates an embodiment of the automatic door operator 30 in more detail.

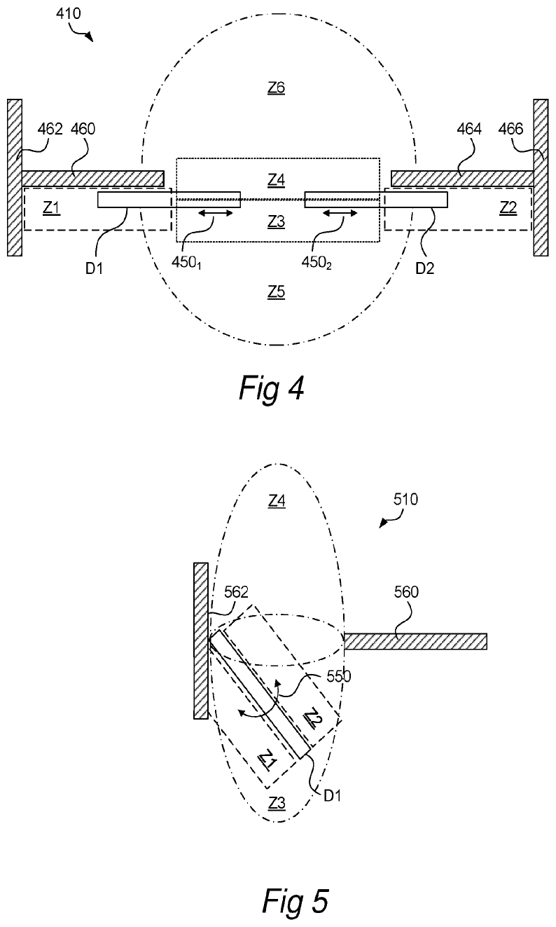

As can be seen in FIG. 1, a control arrangement 20 is provided for the entrance system installation 10. The control arrangement 20 comprises a controller 32, which may be part of the automatic door operator 30 as seen in the embodiment of FIG. 2, but which may be a separate device in other embodiments. The control arrangement 20 also comprises a plurality of sensor units S1 . . . Sn. Each sensor unit may generally be connected to the controller 32 by wired connections, wireless connections, or any combination thereof. As will be exemplified in the subsequent description of the three different embodiments in FIGS. 4, 5 and 6, each sensor unit is arranged to monitor a respective zone Z1 . . . Zn at the entrance system 10 for presence or activity of a person or object. The person may be an individual who is present at the entrance system 10, is approaching it or is departing from it. The object may, for instance, be an animal or an article in the vicinity of the entrance system 10, for instance brought by the aforementioned individual. Alternatively, the object may be a vehicle or a robot.

The embodiment of the automatic door operator 30 shown in FIG. 2 will now be described in more detail. The automatic door operator 30 may typically be arranged in conjunction with a frame or other structure which supports the door members D1 . . . Dm for movements between closed and open positions, often as a concealed overhead installation in or at the frame or support structure.

In addition to the aforementioned controller 32, the automatic door operator 30 comprises a motor 34, typically an electrical motor, being connected to an internal transmission or gearbox 35. An output shaft of the transmission 35 rotates upon activation of the motor 34 and is connected to the external transmission mechanism 40. The external transmission mechanism 40 translates the motion of the output shaft of the transmission 35 into an opening or a closing motion of one or more of the door members D1 . . . Dm with respect to the frame or support structure.

The automatic door operator 30 has a power unit 38b that supplies power to the electric motor 34, controller 32 and other components of the automatic door operator 30 as appropriate. The power unit 50 typically comprises an AC/DC converter, such as a switch mode power supply (SMPS), having an input end coupled to AC mains 38a and an output end for supplying internal DC power to the electric motor 34, controller 32, etc.

In addition to the power unit 38b, the automatic door operator 30 furthermore comprises a battery 39 that may also supply power to the electric motor 34, etc., for instance in an evacuation operating mode of the automatic door operator 30, or in times of AC mains power shortage. In the disclosed embodiment, the battery 39 is coupled for charging by the power unit 38b. In other embodiments, the battery 39 may be charged by other means, such as external battery charging equipment. Preferably, therefore, the battery 39 is a rechargeable battery made from, for instance, lithium-ion (Li-ion), lithium-ion polymer (Li-ion polymer), nickel-metal hydride (NiMH), nickel-cadmium (NiCd) or lead-acid technology.

The controller 32 is arranged for performing different functions of the automatic door operator 30, typically in different operational modes (states) of the entrance system installation 10, using inter alia sensor input data from the plurality of sensor units S1 . . . Sn. Hence, the controller 32 is operatively connected with the plurality of sensor units S1 . . . Sn. At least some of the different functions performable by the controller 32 have the purpose of causing desired movements of the door members D1 . . . Dm. To this end, the controller 32 has at least one control output connected to the motor 34 for controlling the actuation thereof.

The controller 32 may be implemented in any known controller technology, including but not limited to a microcontroller, processor (e.g. PLC, CPU, DSP), FPGA, ASIC or any other suitable digital and/or analog circuitry capable of performing the intended functionality.

The controller 32 also has an associated memory 33. The memory 33 may be implemented in any known memory technology, including but not limited to E(E)PROM, S(D)RAM or flash memory. In some embodiments, the memory 33 may be integrated with or internal to the controller 32. The memory 33 may store program instructions for execution by the controller 32, as well as temporary and permanent data used by the controller 32.

In the embodiment shown in FIG. 2, the entrance system 10 has a communication bus 37. Some or all of the plurality of sensor units S1 . . . Sn are connected to the communication bus 37, and so is the automatic door operator 30. In the disclosed embodiment, the controller 32 and the memory 33 of the automatic door operator 30 are connected to the communication bus 37; in other embodiments it may be other devices or components of the automatic door operator 30. In still other embodiments, the outputs of the plurality of sensor units S1 . . . Sn may be directly connected to respective data inputs of the controller 32.

The automatic door operator 30 in FIG. 2 is enabled for external data communication 36a by means of a data communication interface 36b which is furthermore connected to the communication bus 37 at 36b. The external data communication 36a is typically made with another communication device or system over a data communication network 36c, such as a wide area network (WAN) or local area network (LAN). Accordingly, the data communication network 36c may comply with any commercially available mobile telecommunications standard, including but not limited to GSM, UMTS, LTE, 5G, D-AMPS, CDMA2000, FOMA and TD-SCDMA. Alternatively or additionally, the data communication network 36c may comply with one or more short-range wireless data communication standards such as Bluetooth®, BLE, WiFi (e.g. IEEE 802.11, wireless LAN), Near Field Communication (NFC), RFID (Radio Frequency Identification) or Infrared Data Association (IrDA). In some embodiments, the communication may be wired, such as TCP/IP over Ethernet.

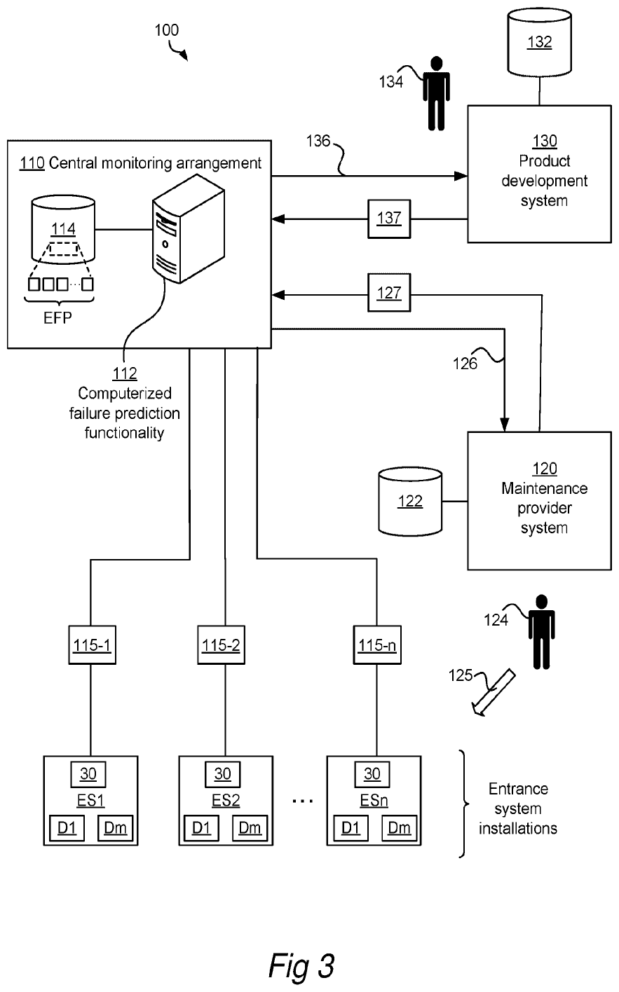

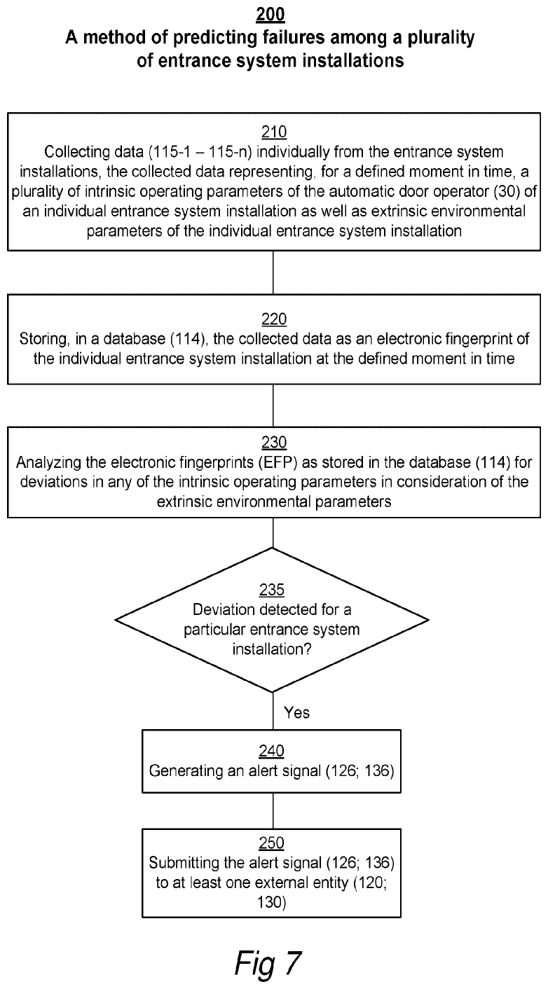

A novel and inventive way of doing failure prediction for a plurality of entrance system installations (one of which may be the entrance system installation 10 in FIG. 1) will now be described with reference to a system 100 in FIG. 3. A corresponding failure prediction method is seen at 200 in FIG. 7, and accordingly FIG. 7 will be referred to in parallel with FIG. 3 in the following description.

As can be seen in FIG. 3, the system 100 comprises a central monitoring arrangement 110 and a plurality of entrance system installations ES1-ESn. Each individual entrance system installation ES1, ES2, . . . , ESn has one or more movable door members D1 . . . Dm (also see, for instance, FIG. 1) and an automatic door operator 30 (also see, for instance, FIG. 2) for causing movements of the one or more movable door members D1 . . . Dm between closed and open positions. Each individual entrance system installation ES1, ES2, . . . , ESn is configured for repeatedly providing data 115-1 . . . 115-n to the central monitoring arrangement 110. The data 115-1 . . . 115-n may be obtained by a controller in the automatic door operator 30, such as controller 32 in FIG. 2, or by another unit in the entrance system installation, and communicated over a data communication network using a data communication interface (see, for instance, data communication network 36c and data communication interface 36 in FIG. 2).

The obtained data represents, for a defined moment in time, a plurality of intrinsic operating parameters of the automatic door operator 30 of the individual entrance system installation ES1, ES2 or ESn, as well as extrinsic environmental parameters of that individual entrance system installation.

The intrinsic operating parameters of the automatic door operator 30 represent properties or characteristics of one or more components, parts or sub-system of the automatic door operator 30 that can be measured, read or otherwise determined as a direct result of the operation of the automatic door operator. Examples of such components, parts or sub-system of the automatic door operator 30 are the motor 34, the transmission 35, the sensor units S1 . . . Sn and the battery 39 of the automatic door operator 30.

The extrinsic environmental parameters of the individual entrance system installation ES1, ES2 or ESn represent properties or characteristics of the entrance system installation's operating environment. An extrinsic environmental parameter is thus extrinsic in that it does not directly relate to the internal operation of the components, parts or sub-system of the automatic door operator 30 but is rather representative of the contextual environment, i.e. the conditions, of the individual entrance system installation ES1, ES2 or ESn in which the automatic door operator operates 30. Examples of such conditions represented by the extrinsic environmental parameter are temperature, humidity, air pressure, wind load, time of day, weekday, season, operating mode of the automatic door operator, sensor activation sequence (e.g. the order in which the sensor units S1 . . . Sn are triggered), and activation pattern of the movable door members (e.g. how frequently they are actuated, or how long it was since the last actuation).

A purpose of the central monitoring arrangement 110 is to predict failures among the monitored entrance system installations ES1-ESn, and to initiate appropriate action when applicable. To this end, the central monitoring arrangement 110 comprises computerized failure prediction functionality 112 and a database 114. The computerized failure prediction functionality 112 may, for instance, be implemented by a server computer, a cluster of server computers or by cloud-based resources such as Amazon AWS, Microsoft Azure or Google Cloud. The database 114 may, for instance, be implemented as a DBaaS (Database-as-a-service). Some exemplary database technologies include MySQL, PostgreSQL, Oracle RDBMS, Amazon DynamoDB, MongoDB, Hadoop, Apache Cassandra, Amazon Aurora, EnterpriseDB, Oracle Database Cloud Service or Google Cloud.

As can be seen also in FIG. 7, the computerized failure prediction functionality 112 is configured for repeatedly collecting data 115-1-115-n individually from the entrance system installations ES1-ESn. See step 210 in FIG. 7. The collected data is the data obtained by the respective individual entrance system installation ES1, ES2, . . . , ESn, as described above. Each set of collected data 115-1, 115-2 or 115-n thus represents, for a defined moment in time, a plurality of intrinsic operating parameters of the automatic door operator 30 of an individual entrance system installation as well as extrinsic environmental parameters of that individual entrance system installation.

The computerized failure prediction functionality 112 is configured for storing, in the database 114, the collected data 115-1, 115-2 or 115-n as an electronic fingerprint of the individual entrance system installation at the defined moment in time. See step 220 in FIG. 7.

The collecting 210 and storing 220 of the data ES1-ESn may be scheduled to occur at appropriate intervals, such as hourly or daily. Shorter or longer periodicity is also possible. The scheduling may be handled by each individual entrance system installation itself by pushing data 115-1, 115-2 or 115-n to the central monitoring arrangement 110 over the data communication network 36c. Alternatively, the scheduling may be handled by the central monitoring arrangement 110 by requesting (pulling) data from the entrance system installations 115-1-115-n. As a further alternative, the collecting 210 and storing 220 of the data ES1-ESn may occur on a non-deterministic (random) basis.

The data thus gathered over time as electronic fingerprints EFP in the database 114 will be processed and used by the computerized failure prediction functionality 112 to analyze the electronic fingerprints EFP as stored in the database 114 for deviations in any of the intrinsic operating parameters in consideration of the extrinsic environmental parameters. See step 230 in FIG. 7.

Upon detection of a deviation for a particular entrance system installation, such as for instance ES1 in FIG. 3, the computerized failure prediction functionality 112 is configured for generating an alert signal 126; 136, and for submitting the alert signal 126; 136 to at least one external entity 120; 130. See steps 235-250 in FIG. 7. Examples of such applications will be presented further below.

In some embodiments, the deviation in step 235 is detected between stored electronic fingerprints EFP of one and the same individual entrance system installation (such as, for instance, ES1 in FIG. 3), being said particular entrance system installation. In such cases, the analyzing in step 230 will thus be confined to electronic fingerprints EFP from the same individual entrance system installation, i.e. a separate analysis is made for each individual entrance system installation. This allows for expedient detection of a failure of a certain entrance system installation, based solely on its own fingerprints.

Alternatively or additionally, the deviation in step 235 may beneficially be detected between one or more stored electronic fingerprints EFP of the particular entrance system installation (such as, for instance, ES1 in FIG. 3) and one or more stored electronic fingerprints EFP of a plurality of other individual entrance system installations (such as, for instance, any of ES2-ESn in FIG. 3). In such cases, the analyzing in step 230 will target electronic fingerprints EFPs from several entrance system installations, typically having something in common like being of a same product type, product line or product platform, originating from the same vendor, belonging to the same venue owner, etc. In other words, joint analyses of stored electronic fingerprints EFPs will be made for several individual entrance system installations. This approach will broaden the base for predicting failures by including entrance system installations from different sites, areas or countries and hence improve the versatility of the inventive failure prediction.

In preferred embodiments, the analyzing in step 230 of the stored electronic fingerprints EFP involves comparing intrinsic operating parameters from different electronic fingerprints EFP for which one or more of the extrinsic environmental parameters are essentially the same. In even more preferred embodiments, the analyzing in step 230 of the stored electronic fingerprints EFP involves comparing intrinsic operating parameters from different electronic fingerprints EFP for which all of the extrinsic environmental parameters are essentially the same.

A criterion for when a first electronic fingerprint is considered to have an extrinsic environmental parameter which is essentially the same as that of a second electronic fingerprint may be when the value of the extrinsic environmental parameter in the first electronic fingerprint is identical to or differs by only a given threshold extent (such as 1%, 5%, 10% or any percentage there between) from the value of the same extrinsic environmental parameter in the second electronic fingerprint.

Confining the deviation analysis to electronic fingerprints EFP for which the values of the extrinsic environmental parameters are identical or differ to a threshold extent only will improve the accuracy of the inventive failure prediction, facilitate the analysis and minimize the risk of detecting spurious deviations (e.g. false positives).

In advantageous embodiments of the central monitoring arrangement 110, the alert signal 126; 136 identifies the particular entrance system installation (e.g. ES1) for which the deviation has been detected in step 235. The alert signal 126; 136 may further define a nature of a predicted failure for the particular entrance system installation ES1 for which the deviation has been detected. This may, for instance, be done by providing the alert signal 126; 136 with information that indicates a component or functionality in the particular entrance system installation ES1 that is at risk and should be replaced or attended to by service personnel 124.

To this end, the system 100 may include a computerized maintenance provider system 120, as can be seen in FIG. 3, The alert signal 126 sent to this external entity will enable a maintenance provider to send 125 service personnel 124 to the individual entrance system installation ES1 for which the deviation has been identified, in order to perform an action of inspection, maintenance, upgrade or spare part replacement at the individual entrance system installation ESE, so as to preempt a potential malfunction.

Advantageously, the computerized failure prediction functionality 112 of the central monitoring arrangement 110 is configured to receive, from the computerized maintenance provider system 120, service performance information 127 from a maintenance database 122 about an action of inspection, maintenance, upgrade or spare part replacement having been performed on any of the individual entrance system installations ES1-ESn, and to store the service performance information 127 in the database 114 in association with the entrance system installation (ES2) in question. The analyzing in step 230 of the electronic fingerprints EFP for deviations may then take such stored service performance information into consideration. This may improve the accuracy of the failure prediction for various reasons. The risk of an imminent failure might be considered as being lower if an action of inspection or maintenance has taken place recently. This may call for an increase in deviation threshold to cause an alarm. Conversely, when there has been no recent inspection or maintenance, a lower deviation threshold may be applied.

In some embodiments, the aforementioned at least one external entity in the system 100 includes a computerized product development system 130. Receiving the alert signal 136 from the central monitoring arrangement 110 will enable product developers 134 to stay informed of entrance system components or functionalities for which a failure has been predicted and proactively make changes in the design of such components or functionalities, or of related components or functionalities (for instance belonging to the same family of components, or being based on a same product platform). The change may be propagated to a product design database 132.

In some embodiments, the computerized failure prediction functionality 112 is further configured for receiving, from the computerized product development system 130, product upgrade information 137 from product design database 132 that pertains to one or more of the individual entrance system installations ES1-ESn, and for storing the product upgrade information 137 in the database 114 in association with the one or more individual entrance system installation in question. The analyzing in step 230 of the electronic fingerprints EFP for deviations may then take such stored product upgrade information into consideration. This may improve the accuracy of the failure prediction, since the analysis will be based on updated information on the components and functionalities of the automatic door operators and entrance system installations being monitored.

The analysis in step 230 may be done with respect to short-term deviations or long-term deviations, as the case may be. For a short-term deviation it may suffice that a deviation in one of the intrinsic operating parameters is detected for a few, or even just two, electronic fingerprints EFP collected subsequently to each other in time. Detecting a short-term deviation may benefit from a quick reaction time, but potentially at the expense of a higher risk for spurious failure detections (false positives). On the other hand, for a long-term deviation to be considered as having being detected in step 235, if may be required that the deviations appear (to a constant or progressing extent) in a larger number of electronic fingerprints EFP and/or in a number of electronic fingerprints EFP taken at temporally separate moments in time (e.g. at different days, weeks or months). This may be beneficial to avoid spurious failure detections and/or for detecting slowly progressing deviations.

One example of data that is interesting to monitor is the required energy for one opening of the movable door members D1-Dm. This data will be calculated locally at the individual entrance system installation and will be a combination of motor current, motor voltage and opening time. The data value thus compiled (i.e. being one of the intrinsic operating parameters of the collected data 115-1-115-n) may be affected by both wear and tear, temperature, humidity, air pressure difference and wind load. The present invention will enable the failure prediction to react only on deviating data related to worn out or broken parts in the entrance system installation that requires service or other interaction with the product, while ignoring problems related solely to outer circumstances.

A sample list of collected data (intrinsic operating parameters) and {outer circumstances that must be considered (extrinsic environmental parameters)} [problems that can be identified] is presented below.
Opening energy {Temperature, Humidity, Opening after a long rest or frequent openings} [Worn motor, worn gearbox, worn transmission, worn support guides]
Closing energy {Temperature, Humidity, Opening after a long rest or frequent openings} [Worn motor, worn gearbox, worn transmission, worn support guides]
Reopening energy {Temperature, Humidity, Opening after a long rest or frequent openings} [Worn motor, worn gearbox, worn transmission, worn support guides]
Battery inner resistance {Temperature, Time after test, Time since discharged} [Battery condition and ability to fulfill requirements]
Battery No load Voltage {Temperature, Time after test, Time since discharged} [Battery condition and ability to fulfill requirements]
Battery Capacity {Temperature, Time after test, Time since discharged} [Battery condition and ability to fulfill requirements]
Motor inner resistance {Temperature} [Motor brushes worn, Motor overheated, Not original motor]
Sensor activation sequence {Temperature, Time of day} [Sensor functionality, Sensor adjustments]
Sensor non-activation sequence {Temperature, Time of day, Door position} [Sensor functionality, Sensor adjustments]

Three different exemplifying embodiments of entrance system installations, for instance any of the aforementioned entrance system installations 10, ES1, ES2, ESn, will now be described with reference to FIGS. 4, 5 and 6.

Turning first to FIG. 4, a first embodiment of an entrance system installation in the form of a sliding door system 410 is shown in a schematic top view. The sliding door system 410 comprises first and second sliding doors or wings D1 and D2, being supported for sliding movements 450₁ and 450₂ in parallel with first and second wall portions 460 and 464. The first and second wall portions 460 and 464 are spaced apart; in between them there is formed an opening which the sliding doors D1 and D2 either blocks (when the sliding doors are in closed positions), or makes accessible for passage (when the sliding doors are in open positions). An automatic door operator (not seen in FIG. 4 but referred to as 30 in FIGS. 1 and 2) causes the sliding movements 450₁ and 450₂ of the sliding doors D1 and D2.

The sliding door system 410 comprises a plurality of sensor units, each monitoring a respective zone Z1-Z6. The sensor units themselves are not shown in FIG. 4, but they are generally mounted at or near ceiling level and/or at positions which allow them to monitor their respective zones Z1-Z6. To facilitate the reading, each sensor unit will be referred to as Sx in the following, where x is the same number as in the zone Zx it monitors (Sx being selected from {S1 . . . S6}, Zx being selected from {Z1-Z6}.

A first sensor unit S1 is mounted at a lateral positon to the far left in FIG. 4 to monitor zone Z1. The first sensor unit S1 is a side presence sensor, and the purpose is to detect when a person or object occupies a space between the outer lateral edge of the sliding door D1 and an inner surface of a wall or other structure 462 when the sliding door D1 is moved towards the left in FIG. 4 during an opening state of the sliding door system 410. The provision of the side presence sensor S1 will help avoiding a risk that the person or object will be hit by the outer lateral edge of the sliding door D1, and/or jammed between the outer lateral edge of the sliding door D1 and the inner surface of the wall 462, by triggering abort and preferably reversal of the ongoing opening movement of the sliding door D1.

A second sensor unit S2 is mounted at a lateral positon to the far right in FIG. 4 to monitor zone Z2. The second sensor unit S2 is a side presence sensor, just like the first sensor unit S1, and has the corresponding purpose—i.e. to detect when a person or object occupies a space between the outer lateral edge of the sliding door D2 and an inner surface of a wall 466 when the sliding door D2 is moved towards the right in FIG. 4 during the opening state of the sliding door system 410.

A third sensor unit S3 is mounted at a first central positon in FIG. 4 to monitor zone Z3. The third sensor unit S3 is a door presence sensor, and the purpose is to detect when a person or object occupies a space between or near the inner lateral edges of the sliding doors D1 and D2 when the sliding doors D1 are moved towards each other in FIG. 4 during a closing state of the sliding door system 410. The provision of the door presence sensor S3 will help avoiding a risk that the person or object will be hit by the inner lateral edge of the sliding door D1 or D2, and/or be jammed between the inner lateral edges of the sliding doors D1 and D2, by aborting and preferably reversing the ongoing closing movements of the sliding doors D1 and D2.

A fourth sensor unit S4 is mounted at a second central positon in FIG. 4 to monitor zone Z4. The fourth sensor unit S4 is a door presence sensor, just like the third sensor unit S3, and has the corresponding purpose—i.e. to detect when a person or object occupies a space between or near the inner lateral edges of the sliding doors D1 and D2 when the sliding doors D1 are moved towards each other in FIG. 4 during a closing state of the sliding door system 410.

The side presence sensors S1 and S2 and door presence sensors S3 and S4 may be image-based sensor units, active IR (infrared) sensor unit, etc.

A fifth sensor unit S5 is mounted at an inner central positon in FIG. 4 to monitor zone Z5. The fifth sensor unit S5 is an inner activity sensor, and the purpose is to detect when a person or object approaches the sliding door system 410 from the inside of the premises. The provision of the inner activity sensor S5 will trigger the sliding door system 410, when being in a closed state or a closing state, to automatically switch to an opening state for opening the sliding doors D1 and D2, and then make another switch to an open state when the sliding doors D1 and D2 have reached their fully open positions.

A sixth sensor unit S6 is mounted at an outer central positon in FIG. 4 to monitor zone Z6. The sixth sensor unit S6 is an outer activity sensor, and the purpose is to detect when a person or object approaches the sliding door system 410 from the outside of the premises. Similar to the inner activity sensor S5, the provision of the outer activity sensor S6 will trigger the sliding door system 410, when being in its closed state or its closing state, to automatically switch to the opening state for opening the sliding doors D1 and D2, and then make another switch to an open state when the sliding doors D1 and D2 have reached their fully open positions.

The inner activity sensor S5 and the outer activity sensor S6 may, for instance, be radar (microwave) sensor units or image-based sensor units.

A second embodiment of an entrance system installation in the form of a swing door system 510 is shown in a schematic top view in FIG. 5. The swing door system 510 comprises a single swing door D1 being located between a lateral edge of a first wall 560 and an inner surface of a second wall 562 which is perpendicular to the first wall 560. The swing door D1 is supported for pivotal movement 550 around pivot points on or near the inner surface of the second wall 562. The first and second walls 560 and 562 are spaced apart; in between them an opening is formed which the swing door D1 either blocks (when the swing door is in closed position), or makes accessible for passage (when the swing door is in open position). An automatic door operator (not seen in FIG. 5 but referred to as 30 in FIGS. 1 and 2) causes the movement 550 of the swing door D1.

The swing door system 510 comprises a plurality of sensor units, each monitoring a respective zone Z1-Z4. The sensor units themselves are not shown in FIG. 5, but they are generally mounted at or near ceiling level and/or at positions which allow them to monitor their respective zones Z1-Z4. Again, each sensor unit will be referred to as Sx in the following, where x is the same number as in the zone Zx it monitors (Sx being selected from {S1 . . . S4}, Zx being selected from {Z1-Z4}.

A first sensor unit S1 is mounted at a first central positon in FIG. 5 to monitor zone Z1. The first sensor unit S1 is a door presence sensor, and the purpose is to detect when a person or object occupies a space near a first side of the (door leaf of the) swing door D1 when the swing door D1 is being moved towards the open position during an opening state of the swing door system 510. The provision of the door presence sensor S1 will help avoiding a risk that the person or object will be hit by the first side of the swing door D1 and/or be jammed between the first side of the swing door D1 and the second wall 562; a sensor detection in this situation will trigger abort and preferably reversal of the ongoing opening movement of the swing door D1.

A second sensor unit S2 is mounted at a second central positon in FIG. 5 to monitor zone Z2. The second sensor unit S2 is a door presence sensor, just like the first sensor S1, and has the corresponding purpose—i.e. to detect when a person or object occupies a space near a second side of the swing door D1 (the opposite side of the door leaf of the swing door D1) when the swing door D1 is being moved towards the closed position during a closing state of the swing door system 510. Hence, the provision of the door presence sensor S2 will help avoiding a risk that the person or object will be hit by the second side of the swing door D1 and/or be jammed between the second side of the swing door D1 and the first wall 560; a sensor detection in this situation will trigger abort and preferably reversal of the ongoing closing movement of the swing door D1.

The door presence sensors S1 and S2 may be image-based sensor units, active IR (infrared) sensor units, etc.

A third sensor unit S3 is mounted at an inner central positon in FIG. 5 to monitor zone Z3. The third sensor unit S3 is an inner activity sensor, and the purpose is to detect when a person or object approaches the swing door system 510 from the inside of the premises. The provision of the inner activity sensor S3 will trigger the sliding door system 510, when being in a closed state or a closing state, to automatically switch to an opening state for opening the swing door D1, and then make another switch to an open state when the swing door D1 has reached its fully open position.

A fourth sensor unit S4 is mounted at an outer central positon in FIG. 5 to monitor zone Z4. The fourth sensor unit S4 is an outer activity sensor, and the purpose is to detect when a person or object approaches the swing door system 510 from the outside of the premises. Similar to the inner activity sensor S3, the provision of the outer activity sensor S4 will trigger the swing door system 510, when being in its closed state or its closing state, to automatically switch to the opening state for opening the swing door D1, and then make another switch to an open state when the swing door D1 has reached its fully open position.

The inner activity sensor S3 and the outer activity sensor S4 may, for instance, be radar (microwave) sensor units or image-based sensor units.

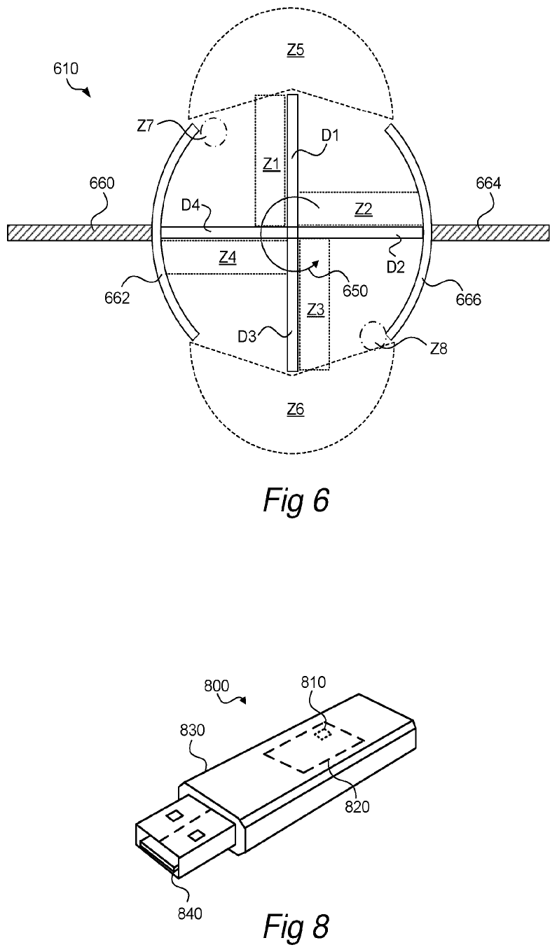

A third embodiment of an entrance system installation in the form of a revolving door system 610 is shown in a schematic top view in FIG. 6. The revolving door system 610 comprises a plurality of revolving doors or wings D1-D4 being located in a cross configuration in an essentially cylindrical space between first and second curved wall portions 662 and 666 which, in turn, are spaced apart and located between third and fourth wall portions 660 and 664. The revolving doors D1-D4 are supported for rotational movement 650 in the cylindrical space between the first and second curved wall portions 662 and 666. During the rotation of the revolving doors D1-D4, they will alternatingly prevent and allow passage through the cylindrical space. An automatic door operator (not seen in FIG. 6 but referred to as 30 in FIGS. 1 and 2) causes the rotational movement 650 of the revolving doors D1-D4.

The revolving door system 610 comprises a plurality of sensor units, each monitoring a respective zone Z1-Z8. The sensor units themselves are not shown in FIG. 6, but they are generally mounted at or near ceiling level and/or at positions which allow them to monitor their respective zones Z1-Z8. Again, each sensor unit will be referred to as Sx in the following, where x is the same number as in the zone Zx it monitors (Sx being selected from {S1 . . . S8}, Zx being selected from {Z1-Z8}.

First to fourth sensor units S1-S4 are mounted at respective first to fourth central positons in FIG. 6 to monitor zones Z1-Z4. The first to fourth sensor units S1-S4 are door presence sensors, and the purpose is to detect when a person or object occupies a respective space (sub-zone of Z1-Z4) near one side of the (door leaf of the) respective revolving door D1-D4 as it is being rotationally moved during a rotation state or start rotation state of the revolving door system 610. The provision of the door presence sensors S1-S4 will help avoiding a risk that the person or object will be hit by the approaching side of the respective revolving door D1-D4 and/or be jammed between the approaching side of the respective revolving door D1-D4 and end portions of the first or second curved wall portions 662 and 666. When any of the door presence sensors S1-S4 detects such a situation, it will trigger abort and possibly reversal of the ongoing rotational movement 650 of the revolving doors D1-D4.

The door presence sensors S1-S4 may, for instance, be image-based sensor units or active IR (infrared) sensor units.

A fifth sensor unit S5 is mounted at an inner non-central positon in FIG. 6 to monitor zone Z5. The fifth sensor unit S5 is an inner activity sensor, and the purpose is to detect when a person or object approaches the revolving door system 610 from the inside of the premises. The provision of the inner activity sensor S5 will trigger the revolving door system 610, when being in a no rotation state or an end rotation state, to automatically switch to a start rotation state to begin rotating the revolving doors D1-D4, and then make another switch to a rotation state when the revolving doors D1-D4 have reached full rotational speed.

A sixth sensor unit S6 is mounted at an outer non-central positon in FIG. 6 to monitor zone Z6. The sixth sensor unit S6 is an outer activity sensor, and the purpose is to detect when a person or object approaches the revolving door system 610 from the outside of the premises. Similar to the inner activity sensor S5, the provision of the outer activity sensor S6 will trigger the revolving door system 610, when being in its no rotation state or end rotation state, to automatically switch to the start rotation state to begin rotating the revolving doors D1-D4, and then make another switch to the rotation state when the revolving doors D1-D4 have reached full rotational speed.

The inner activity sensor S5 and the outer activity sensor S6 may, for instance, be radar (microwave) sensors units or image-based sensor units.

Seventh and eighth sensor units S7 and S8 are mounted near the ends of the first or second curved wall portions 662 and 666 to monitor zones Z7 and Z8. The seventh and eighth sensor units S7 and S8 are vertical presence sensors. The provision of these sensor units S7 and S8 will help avoiding a risk that the person or object will be jammed between the approaching side of the respective revolving door D1-D4 and an end portion of the first or second curved wall portions 662 and 666 during the start rotation state and the rotation state of the revolving door system 610. When any of the vertical presence sensors S7-S8 detects such a situation, it will trigger abort and possibly reversal of the ongoing rotational movement 650 of the revolving doors D1-D4.

The vertical presence sensors S7-S8 may, for instance, be image-based sensor units or active IR (infrared) sensor units.

FIG. 8 is a schematic illustration of a computer-readable medium 800 in one exemplary embodiment, capable of storing a computer program product 810. The computer-readable medium 800 in the disclosed embodiment is a memory stick, such as a Universal Serial Bus (USB) stick; the computer-readable medium 800 may however be embodied in various other ways instead, as is well known per se to the skilled person. The USB stick 800 comprises a housing 830 having an interface, such as a connector 840, and a memory chip 820. In the disclosed embodiment, the memory chip 820 is a flash memory, i.e. a non-volatile data storage that can be electrically erased and re-programmed.

The memory chip 820 stores the computer program product 810 which is programmed with computer program code (instructions) that when loaded into and executed by a processing device, such as a CPU, will perform the method 200 of predicting failures among a plurality of entrance system installations, as described above with reference to FIG. 7, in any or all of its disclosed embodiments. The USB stick 800 is arranged to be connected to and read by a reading device for loading the instructions into the processing device. The processing device may, for instance, be comprised in the computerized failure prediction functionality 112 in FIG. 3.

It should be noted that a computer-readable medium can also be other mediums such as compact discs, digital video discs, hard drives or other memory technologies commonly used. The computer program code (instructions) can also be downloaded from the computer-readable medium via a wireless interface to be loaded into the processing device.

The invention has been described above in detail with reference to embodiments thereof. However, as is readily understood by those skilled in the art, other embodiments are equally possible within the scope of the present invention, as defined by the appended claims.

1. A central monitoring arrangement (110) for a plurality of entrance system installations (10; ES1-ESn), each having one or more movable door members (D1 . . . Dm) and an automatic door operator (30) for causing movements of the one or more movable door members (D1 . . . Dm) between closed and open positions, the central monitoring arrangement comprising computerized failure prediction functionality (112) and a database (114), wherein the computerized failure prediction functionality (112) is configured for:
repeatedly collecting data (115-1-115-n) individually from the entrance system installations, the collected data representing, for a defined moment in time, a plurality of intrinsic operating parameters of the automatic door operator (30) of an individual entrance system installation as well as extrinsic environmental parameters of the individual entrance system installation;
storing, in the database (114), the collected data as an electronic fingerprint of the individual entrance system installation at the defined moment in time;
analyzing the electronic fingerprints (EFP) as stored in the database (114) for deviations in any of the intrinsic operating parameters in consideration of the extrinsic environmental parameters; and
upon detection of a deviation for a particular entrance system installation (ES1):
generating an alert signal (126; 136); and
submitting the alert signal (126; 136) to at least one external entity (120; 130).

2. The central monitoring arrangement (110) as defined in claim 1, wherein the deviation is detected between stored electronic fingerprints (EFP) of one and the same individual entrance system installation (ES1), being said particular entrance system installation (ES1).

3. The central monitoring arrangement (110) as defined in claim 1, wherein the deviation is detected between one or more stored electronic fingerprints (EFP) of the particular entrance system installation (ES1) and one or more stored electronic fingerprints (EFP) of a plurality of other individual entrance system installations (ES2-ESn).

4. The central monitoring arrangement (110) as defined in claim 1, wherein the analyzing of the stored electronic fingerprints (EFP) involves comparing intrinsic operating parameters from different electronic fingerprints (EFP) for which one or more of the extrinsic environmental parameters are essentially the same.

5. The central monitoring arrangement (110) as defined in claim 1, wherein the analyzing of the stored electronic fingerprints (EFP) involves comparing intrinsic operating parameters from different electronic fingerprints (EFP) for which all of the extrinsic environmental parameters are essentially the same.

6. The central monitoring arrangement (110) as defined in claim 1, wherein the alert signal (126; 136) identifies the particular entrance system installation (ES1) for which the deviation has been detected.

7. The central monitoring arrangement (110) as defined in claim 6, wherein the alert signal (126; 136) further defines a nature of a predicted failure for the particular entrance system installation (ES1) for which the deviation has been detected.

8. The central monitoring arrangement (110) as defined in claim 1, wherein said at least one external entity comprises a computerized maintenance provider system (120).

9. The central monitoring arrangement (110) as defined in claim 8, wherein the computerized failure prediction functionality (112) is configured for:
receiving, from the computerized maintenance provider system (120), service performance information (127) about an action of inspection, maintenance, upgrade or spare part replacement having been performed on any of the individual entrance system installations (10; ES1-ESn); and
storing the service performance information (127) in the database (114) in association with the entrance system installation in question,
wherein the analyzing of the electronic fingerprints (EFP) for deviations takes stored service performance information into consideration.

10. The central monitoring arrangement (110) as defined in claim 1, wherein said at least one external entity comprises a computerized product development system (130).

11. The central monitoring arrangement (110) as defined in claim 10, wherein the computerized failure prediction functionality (112) is configured for:
receiving, from the computerized product development system (130), product upgrade information (137) pertaining to one or more of the individual entrance system installations (10; ES1-ESn); and
storing the product upgrade information (137) in the database (114) in association with the one or more individual entrance system installation (ES2) in question,
wherein the analyzing of the electronic fingerprints (EFP) for deviations takes stored product upgrade information into consideration.

12. A system (100) comprising;
a central monitoring arrangement (110) as defined in claim 1; and
a plurality of entrance system installations (10; ES1-ESn), each individual entrance system installation having one or more movable door members (D1 . . . Dm) and an automatic door operator (30) for causing movements of the one or more movable door members (D1 . . . Dm) between closed and open positions, and each individual entrance system installation being configured for repeatedly providing data (115-1 . . . 115-n) to the central monitoring arrangement (110), wherein the data represents, for a defined moment in time, a plurality of intrinsic operating parameters of the automatic door operator (30) of the individual entrance system installation as well as extrinsic environmental parameters of the individual entrance system installation.

13. A method (200) of predicting failures among a plurality of entrance system installations (10; ES1-ESn), each having one or more movable door members (D1 . . . Dm) and an automatic door operator (30) for causing movements of the one or more movable door members (D1 . . . Dm) between closed and open positions, the method comprising:
repeatedly collecting (210) data (115-1-115-n) individually from the entrance system installations, the collected data representing, for a defined moment in time, a plurality of intrinsic operating parameters of the automatic door operator (30) of an individual entrance system installation as well as extrinsic environmental parameters of the individual entrance system installation;
storing (220), in a database (114), the collected data as an electronic fingerprint of the individual entrance system installation at the defined moment in time;
analyzing (230) the electronic fingerprints (EFP) as stored in the database (114) for deviations in any of the intrinsic operating parameters in consideration of the extrinsic environmental parameters; and
upon detection of a deviation for a particular entrance system installation (ES1):
generating (240) an alert signal (126; 136); and
submitting (250) the alert signal (126; 136) to at least one external entity (120; 130).

14. The method according to claim 13, further comprising
providing a central monitoring arrangement comprising computerized failure prediction functionality configured to perform the steps od repeatedly collecting, storing, analyzing, generating, and submitting.

15. A computer program product comprising computer code for performing the method according to claim 13 when the computer program code is executed by a processing device.

16. A computer readable medium having stored thereon a computer program comprising computer program code for performing the method according to claim 13 when the computer program code is executed by a processing device.
